(19) United States
(12) Patent Application Publication
(10) Pub. No.: US 2004/0076759 A1
(43) Pub. Date: Apr. 22, 2004

(54) Method for coating paper

(76) Inventors: Esa Lehtinen, Helsinki (FI); Vilho Nissinen, Numminen (FI)

Correspondence Address: COHEN, PONTANI, LIEBERMAN & PAVANE, 551 FIFTH AVENUE, SUITE 1210, NEW YORK, NY, 10176, US

(21) Appl. No.: 10/432,477

(22) PCT Filed: Nov. 26, 2001
(86) PCT No.: PCT/FI01/01025

(30) Foreign Application Priority Data
Nov. 24, 2000 (FI) 20002594

(51) Int. Cl. B05D 1/02

(52) U.S. Cl. 427/421

(57) ABSTRACT

The present invention relates to a method for coating a moving web of paper or paper-board, in which method the web to be coated is passed to a coater station, wherein at least one kind of treatment substance is applied to the web surface by spraying. Further according to the method, at least one kind of treatment substance is sprayed onto the web, and the properties of at least one of the treatment substances are actively changed so that the qualities of the finished coating layer are formed not earlier but on the surface of the paper web.

The present invention relates to a method according to the preamble of claim 1 based on spraying techniques adapted for coating a web of paper or paper-board.

In the coating of a paper web on a papermaking machine, the primary goal is to achieve a maximally good quality of paper web surface for printing. To this end, the paper web surface is coated with a uniform or smooth layer of a coating mix. With the increase of running speeds in papermaking machines in combination with higher demands on production efficiency and product quality, it has become necessary to try to avoid the use of kissing-roll coaters, short-dwell coaters and film-transfer coaters through developing alternative coating techniques based on methods not needing a direct contact with the web. Using defect detectors, defects occurring on the paper web are identified and removed during intermediate winding, thus-preventing them from interfering with further processing of the web. Resultingly, stresses imposed on the web that in the prior art have been a hindrance to higher web speeds are eliminated inasmuch no physical contact with the web surface is required and the pressure impact applied to the web being coated remains very small. Hence, the operating efficiency of coating stations and the production capacity of machinery are elevated to a substantially high level.

Noncontacting coating methods are described in, e.g., patent applications PCT/US91/03830, FI 925404 and FI 933323. In this kind of apparatus, the coating mix is. fed into a spray nozzle via a separate duct and atomization of the coating mix is performed with the help of compressed air passed into the nozzle. Patent applications FI 911390, U.S. Pat. No. 248,177 and PCT/FI89/00177 describe applicators wherein the coating mix is atomized in a separate chamber or unit using a combination gas-liquid phase spray nozzle or ultrasonic atomizing techniques. The atomized aerosol is passed into an applicator nozzle, wherefrom the aerosol is directed to the surface of the paper web by means of injecting therewith a separate carrier gas. The portion of the atomized coating mix that fails to adhere to the web is returned by suction back to the coating mix circulation. In the apparatus described in patent application PCT/FI93/00453, the coat is applied using the above-described methods and then leveled using a doctor unit. Patent applications PCT/FI96/00525 and PCT/FI96/00526 describe a method wherein the coating of the paper web is impinged onto the web surface by means of high-pressure nozzles. In this method, the fluid coating is atomized by passing the flowable coating mix under high pressure via a small-orifice nozzle.

The newest noncontacting coating techniques are based on atomization, or dispersion, of fluid coating material into small droplets. The type of spray is categorized according to the cross-sectional shape of the spray jet produced by a nozzle. The jet may have the shape of a hollow or solid conical spray or of a fanned spray. Spray coverage is defined as the width of the spray pattern at a certain distance from the nozzle tip. The spray angle is the opening angle of the spray emitted by the nozzle.

Atomization nozzles fall into four different classes:

1) high-pressure airless atomizers,

2) atomizers based on rotary centrifugal atomization,

3) air-assist and air-blast nozzles, and

4) other methods.

High-pressure atomizers are characterized in that therein atomization occurs driven alone by the internal pressure of the fluid being atomized thus disposing with the need for dispersing air.

A benefit of spray-coating methods is that they permit coating application to a paper web at any point of a papermaking machine or coater. A spray-coating technique is particularly well suited for use in combination with wet-on-web application methods.

In a papermaking machine or coater, the spray nozzles are adapted in multiple rows at desired points along the web travel, spaced apart from each other at desired distances.

Successful fluid atomization, or dispersion, requires that both the viscosity and also the elasticity of the coating mix to be applied are low. On the other hand, it is desirable that the viscosity of the coating mix after application to the surface of the base paper or, at least, of the coating layer already applied to the base paper surface is sufficiently high. This is a crucial requirement particularly for maintaining a good coating power of the coat.

It is an object of the invention to utilize coating methods operating without physical contact to the paper web in order to thereby provide a coating method, wherein the qualities of the finished coating layer can be modified through applying controlled amounts of differently acting substances to the web surface.

According to the invention, this goal can be achieved by way of spraying at least one treatment substance to the paper web and actively changing the properties of at least one treatment substance so that the final composition of the coating layer is established not earlier-than on the surface of paper web or during the airborne travel of the coating to the surface of the paper web. Further according to the invention, the properties of the coating material can be selected so that they give an optimal end result. Respectively, the properties of the coating obtained through the use of different kinds of web treatment substances and/or via the combination of different web treatment substances are adapted optimal in terms of the behavior of the coating mix on the surface of the base paper.

According to a first embodiment of the invention, the viscosity of at least one of the sprayed web treatment substances is changed under the effect of another treatment substance, advantageously a coating mix, being sprayed from spray nozzles. By way of adjusting the viscosity of the coating mix suitably low for atomization, the coating mix can be made to render a smooth layer of high coating power on the base paper.

According to a second embodiment of the invention, the web treatment substance, advantageously a coating for a paper web, is applied to the surface of a paper web by spraying from nozzles with the coating material being flowable at an elevated temperature. After cooling, the coating material solidifies on the surface of the paper web. The invention can be utilized, e.g., in the application of certain types of printing inks to the surface of a paper web. After cooling, the ink assumes a solid-state phase thus anchoring itself firmly to the surface of the paper web. In its liquid state, the hot printing ink can be applied with the help of spray nozzles or jet nozzles. A benefit of the method over conventional techniques is a coating process that features a minimal need of drying capacity or can-be run without any drying at all.

According to a third embodiment of the invention, the treatment substance, advantageously a coating for a paper web, to be sprayed via nozzles onto the surface of a paper web may consist of different dyes/pigments that only after reaching the surface of the paper web form the desired hue of color. In the prior art, colored paper-board and paper grades have been manufactured by way of coloring the entire thickness of the paper web into a desired color. As the arrangement according to the invention permits only the surface of the base web to be colored into a desired hue, there is no need to bleach or dye the entire bulk of stock. This feature is an important benefit also in terms of reducing the environmental impact of bleaching. To this end, the excellent coating power of spray or powder application gives a good starting point. In the novel coating system, the components of the coating including pigments, binders, dyes/colors and additives are dosed and mixed just prior to their application to the web or, alternatively, layerwise during the application process. The color hue of the coated paper is monitored by means of a spectrophotometer or an equivalent instrument, whose measurement data is utilized in the control of color/dye metering. The above coating process can be adapted to operate either at the wet end of a papermaking machine or its dryer section.

More specifically, the paper web coating method according to the invention is characterized by what is stated in the characterizing part of claim 1.

The desired outcome according to the first embodiment of the invention can be achieved by way of initially spraying onto the surface of the base paper at least one treatment substance, whose properties are suited to accomplish a change in a reaction with another treatment substance, advantageously a coating for a paper web, that is sprayed simultaneously with or subsequent to the spraying of the first substance. Such a changing property may be, e.g., the viscosity of the coating material. Herein, the viscous properties of the coating material itself can be controlled optimal (suitably fluid) for atomization.

Alternatively, the coating material and the liquid intended to alter the viscosity of the former can be sprayed from their dedicated nozzles simultaneously with each other so that the mixing thereof takes place already (at least partially) during the airborne travel of the components. Hence, the coating material has latest at its landing onto the paper web assumed a viscosity value higher than that of the virgin coating material.

According to a first embodiment of the invention, the web treatment substance may be, e.g., a liquid adjusted to a suitable pH level so that the substance in contact with the coating mix causes appropriate changes in a given component of the coating mix (e.g., in its alkali-expandable latex component) such that thereby the viscosity of the coating mix is elevated to a desired level. Herein, it is possible to use readily available materials or such products whose properties are specifically tailored for this purpose.

Binders exhibiting an increasing viscosity at a decreasing acidity are, e.g., alkali-expandable acrylate-based latex compositions such as NaOH-polyvinylacetate acrylate tai NaOH-styreneacetate acrylate.

According to a second embodiment of the invention, the treatment substance to be sprayed onto the web surface may contain a pH-activatable thickener. The actual coating mix adjusted to a suitable pH is then sprayed thereon. Hereby, the bottom of the applied coating mix layer undergoes thickening while its surface portion can set undisturbed. It is also possible to spray the thickener in multiple stages so that the entire thickness of the coating mix applied to the paper web thickens.

The above-described technique can be used for applying, e.g., a precoat layer in wet-on-wet coating of a paper web, whereby the goal is to make a precoat of a maximum coating power. Thus, the precoat adheres extremely well to the surface of the base paper thereby covering the crests and valleys of the surface profile smoothly. The application of the top coat can be carried out using any conventional coating method.

According to a third embodiment of the invention, the treatment substance to be sprayed onto the surface of the base paper contains a so-called associative thickener capable of chaining latex and pigment particles with each other. The hydrophobic sites of the thickener make bonds with the hydrophobic sites of the pigment and latex molecules. These bonds are not sensitive to changes in pH. An example of this kind of associative thickener is Rhoplex RM-825 commercially available from Rohm&Haas Inc.

According to an embodiment of the invention, the coating can be applied to the surface of the paper web via nozzles when the coating mix is made flowable at an elevated temperature. During spraying, the temperature of the coating mix can be, e.g., 150 to 250° C., advantageously 190 to 210° C. The hot coating mix may be cooled on the paper web surface or, alternatively, allowed to cool down by itself. At the elevated temperature, also a conventional coating mix dries very rapidly due to its own thermal heat content. The invention may be utilized, e.g., in the application of certain types of printing inks to the surface of a paper web. After cooling, the ink assumes a solid-state phase thus anchoring itself firmly to the surface of the paper web. In this fashion, a base paper can be coated with a minimal need of drying capacity or even without any drying at all.

According to a third embodiment of the invention, the coating mix to be applied from nozzles to the surface of a paper web may consist of different dyes/pigments that only after reaching the surface of the paper web form the desired hue of color. As the arrangement according to the invention allows only the surface of the base web to be colored into a desired hue, there is no need to bleach or dye the entire bulk of stock. Hereby, the components of the coating including pigments, binders, dyes/colors and additives are dosed and mixed just-prior to their application to the web or, alternatively, layerwise during the application process. The color hue of the coated paper is monitored by means of a spectrophotometer or an equivalent instrument, whose measurement data is utilized in the control of color/dye metering.

The method according to the invention can be implemented using a spray-coating apparatus equipped with fanned spray nozzles, for instance. It is essential that the spray nozzle system incorporate a control facility for adjusting the mutual distance between the nozzles and the distance of the entire nozzle assembly from the paper web. The nozzle control system may be implemented so that it permits individual spray control for all the nozzles of the system simultaneously. Thus, dedicated control for each one of the nozzles facilitates a desired kind of coating profile control over the cross-machine working area of a given nozzle. With the help of dedicated control of the nozzles, the spray patterns of different treatment substances injected therefrom can be set to react with each other, e.g., by way of adjusting the coverage area of given nozzles to coincide with each other.

One of the problems associated with spray-coating concerns the control of coating material mist. State-of-the-art methods can be utilized in mist control. The coating mix spray must be arranged to operate under such circumstances that a maximally unobstructed travel of the spray to the paper surface is assured; a condition that generally requires the elimination of the boundary air layer traveling along with the running-paper web. The nozzles shall be selected such that are capable of emitting maximally uniform droplets of a relatively large size, whereby the amount of small droplets of low kinetic energy is minimized. The adhesion of small droplets to the paper web must be maximized utilizing, among other techniques, electrical charging, modification of coating mix compositions or by adjusting the impact energy of the spray droplets to a suitable level. Furthermore, it is possible to avail of different kinds of mechanical mist collection systems.

The coating mix to be sprayed must be ejected at a sufficiently high kinetic energy so that the coating droplets generated at a nozzle can spread and adhere well when landing on the surface of the paper web.. At higher web speeds, the droplets must also penetrate through the boundary air layer traveling on the paper web surface.

The cornerstone of a spray-coating apparatus is the coating mix atomization nozzle. The nozzle may be selected to be any one of types mentioned earlier in the state-of-the-art description. Advantageously, the nozzle is an airless high-pressure nozzle. The injection pressure of the fluid coating may be 1 to 1000 bar, advantageously 100 to 300 bar. However, the coating mix does not disperse into sufficiently small droplets if the injection pressure is less than 100 bar.

For sufficiently fine atomization, it is advantageous to use a nozzle with a succession of two or more atomization units. This approach is preferred in order to get a good coat profile. As a nozzle with a single atomization unit tends to make the edges of the spray pattern excessively abrupt, it has been found difficult to combine a great number of parallel-mounted nozzles into an entity capable of rendering a good profile in the coating of a wide web. In contrast, a twin multinozzle with a smooth spray pattern edge is a better choice for assuring a smooth cross-machine profile of the applied coat.

When necessary, a spray unit may be arranged to have at least three different operating states: running state, washing state and nozzle replacement state. The spray unit needs a relatively rigid framework which is sufficiently tightly sealable against a mating surface and whereon different system components such as nozzles or nozzle arrays can be mounted. Additionally, the entire apparatus is fixed by its framework to an external support structure. The framework must have such a design that all the different operational phases including system running, cleaning and servicing can be accomplished. The mounting of nozzles on the framework can be implemented in plural ways. Some conventional alternatives are either to assemble the nozzles in arrays extending over the entire cross-machine width of the spray unit or to have each one of the nozzles separately mounted on the spray unit framework.

Internal flows of the spray unit can be controlled at least by the following means: guide vanes, steam tubes, air injection, wetting and steam-collecting surfaces (for condensation). The feed of coating mix to the nozzles is arranged as appropriate in regard to the type of nozzles used. An essential requirement is to provide individual control for the nozzles or nozzle arrays. This can be accomplished by providing the coating mix feed manifold with a sufficient number of control valves. It must be possible to cut off the coating mix feed to certain nozzles or nozzle arrays when the respective nozzles or nozzle arrays are being serviced or replaced so that the ongoing operation of other nozzles or nozzle arrays is not disturbed. Keywords in the system design are: construction of nozzles, ultrasound technique, electrostatic effects, as well as the employed application technique, distances, spraying angles, aerosol generation and the like.

The method according to the invention can be advantageously adapted in equipment and methods disclosed in patent applications PCT/FI96/00525 and PCT/FI96/00526.

1. A method for coating a moving web of paper or paper-board, in which method the web to be coated is passed to a coater station, wherein at least one kind of treatment substance is applied to the web surface by spraying, characterized in that the method comprises the steps of
spraying at least one kind of treatment substance onto the web, and
actively changing the properties of at least one of the treatment substances so that the qualities of the finished coating layer are formed not earlier but on the surface of the paper web.

2. The method of claim 1, characterized in that the properties of at least one of the treatment substances, advantageously the coating mix, are changed actively by way of mixing thereto another treatment substance.

3. The method of claim 1, characterized in that the properties of at least one of the treatment substances, advantageously the coating mix, are changed actively by way of subjecting the same to a temperature change.

4. The method of claim 1 or 2, characterized in that the viscous properties of at least one of the treatment substances, advantageously the coating mix, are changed actively by way of mixing thereto another treatment substance.

5. The method of any one of claims 1, 2 or 4, characterized in that said viscosity change is effected with the help of an alkali-expandable latex.

6. The method of any one of claims 1, 2 or 4, characterized in that said viscosity change is effected with the help of a thickener activatable by a change in its pH.

7. The method of any one of claims 1, 2 or 4, characterized in that said viscosity change is effected with the help of an associative thickener.

8. The method of claim 1 or 3, characterized in that at least one of the treatment substances, advantageously the coating mix, is first taken to an elevated temperature of 150 to 250° C., advantageously 190 to 210° C., and that the same assumes a solid state when cooling on the surface of the paper web.

9. The method of claim 8, characterized in that there is used at least one such treatment substance, advantageously the coating mix, that contains printing inks.

10. The method of claim 1, characterized in that there is used at least one such treatment substance, advantageously the coating mix, that contains pigments, binders, dyes/colors and/or additives.
